(19) United States
(12) Patent Application Publication
(10) Pub. No.: US 2017/0191837 A1
(43) Pub. Date: Jul. 6, 2017

(54) METHOD FOR INDOOR NAVIGATION AND ELECTRONIC DEVICE

(71) Applicants: LE HOLDINGS (BEIJING) CO., LTD., Beijing (CN); LEMOBILE INFORMATION TECHNOLOGY (BEIJING) CO., LTD, Beijing (CN)

(72) Inventors: Yan YU, Beijing (CN); Chen CHEN, Beijing (CN)

(21) Appl. No.: 15/246,244

(22) Filed: Aug. 24, 2016

Related U.S. Application Data
(63) Continuation of application No. PCT/CN2016/089302, filed on Jul. 8, 2016.

(30) Foreign Application Priority Data
Dec. 30, 2015 (CN) 201511023809.7

(51) Int. Cl. G01C 21/20; G01S 19/03; H04B 10/50; G01S 19/42

(52) U.S. Cl. CPC G01C 21/206; G01S 19/42; G01S 19/03; H04B 10/502

(57) ABSTRACT

An embodiment of the present disclosure discloses a method and a device for indoor navigation. The method comprises the steps of: receiving an infrared carrier wave sent by an LED lamp and acquiring GPS data codes from the infrared carrier wave; analyzing the GPS data codes and obtaining GPS data; determining a current position according to the GPS data; and planning a navigation route between the current position and a target position according to the current position. The method and the device for indoor navigation provided by the embodiment of the present disclosure may realize indoor positioning and indoor navigation.

### CROSS-REFERENCE TO RELATED APPLICATIONS

This application is a continuation of International Application No. PCT/CN2016/089302 filed on Jul. 8, 2016, which is based upon and claims priority to Chinese Patent Application No. 201511023809.7, filed on Dec. 30, 2015, the entire contents of which are incorporated herein by reference.

### TECHNICAL FIELD

The present disclosure generally relates to the technical field of indoor navigation, in particular to a method for indoor navigation and an electronic device.

### BACKGROUND

Along with road construction, economic exchanges between cities have become more and more frequent, and the travel area of human beings is larger and larger. In order to improve life quality, through holding a great amount of leisure activities and exploration activities, people are not limited in small familiar areas, and failure to find correct roads and destinations occurs frequently, so how to acquire a route to a destination is becoming a demand when people go out. Navigation may just meet this demand. Navigation is a method of guiding a certain device to move from one point on a route to another point.

At present, the most widely used navigation technology is GPS (Global Positioning System). The coverage space of the GPS is formed by 21 working satellites in the sky, 20,200 km above the ground. The satellites are uniformly distributed on 6 trajectory planes (4 satellites on each trajectory plane, and a trajectory inclination of 55°. Besides, 3 source backup satellites are moving on the trajectory. Due to the distribution of the satellites, over 4 satellites may be observed at any time at any place on earth, and satellites may pre-store navigation information.

A user device is a GPS signal receiver. Its main function is to capture satellites to be tested which are selected according to a certain satellite drag angle and trace the movement of those satellites. When the receiver captures signals from the traced satellites, the change rates of a fake distance and a distance between a receiving antenna and the satellites may be measured, and data such as satellite trajectory parameters may be modulated. According to these data, a microprocessor in the receiver may perform positioning calculations according to a positioning calculation method, and obtain information such as longitude and latitude, height, speed, time, etc. of a geographic position where a user stands. Receiver hardware, software in the receiver and processing software kits of the GPS data constitute a complete GPS user device. The structure of a GPS receiver includes two parts, namely an antenna unit and a receiving unit. The receiver usually employs internal and external two DC power supplies. The purpose of setting an internal power supply is to ensure uninterrupted observation during replacement of the external power supply. When the external power supply is used, internal batteries are charged automatically. After shutdown, the internal batteries supply power to RAM (Random Access Memory) to prevent data loss. Various types of receivers are becoming smaller and smaller, and lighter and lighter, and convenient for measurement in the field.

Now, more and more large buildings are appearing, with more and more stores and companies therein. People tend to get lost in huge buildings, so indoor navigation is needed. Blocked by buildings, the GPS signal received by the GPS signal receiver and sent by the satellites is very unstable, so existing GPS technology cannot clearly point out the position of a certain company or store in a large building.

Therefore, a technical problem urgently to be solved by a person skilled in the art is to how to perform indoor navigation and plan a route to a target position in large buildings.

### SUMMARY

An embodiment of the present disclosure discloses a method and a device for indoor navigation to solve a technical problem that the prior art fails to realize indoor navigation and plan a route to a target position in large buildings.

To solve the problem above, the embodiment of the present disclosure discloses a method for indoor navigation, comprising: receiving an infrared carrier wave sent by an LED lamp and acquiring GPS data codes from the infrared carrier wave; analyzing the GPS data codes and obtaining GPS data; determining a current position according to the GPS data; and planning a navigation route between the current position and a target position according to the current position.

To solve the problem above, the embodiment of the present disclosure further discloses an electronic device, comprising: at least one processor; and a memory communicably connected with the at least one processor for storing instructions executable by the at least one processor, wherein execution of the instructions by the at least one processor causes the at least one processor to: receive an infrared carrier wave sent by an LED lamp and acquire GPS data codes from the infrared carrier wave; analyze the GPS data codes and obtain GPS data; determine a current position according to the GPS data; and plan a navigation route between the current position and a target position according to the current position.

To solve the problem above, the embodiment of the present disclosure further discloses a non-transitory computer readable medium storing executable instructions that, when executed by an electronic device, cause the electronic device to: receive an infrared carrier wave sent by an LED lamp and acquire GPS data codes from the infrared carrier wave; analyze the GPS data codes and obtain GPS data; determine a current position according to the GPS data; and plan a navigation route between the current position and a target position according to the current position.

According to an embodiment of the present disclosure, there is disclosed a computer program, comprising computer readable codes, operating on an electronic device such that the electronic device executes the method for indoor navigation above.

The method for indoor navigation and electronic device provided by the embodiment of the present disclosure have advantages that: the LED lamp is fixed on a ceiling in a room, and no obstacles exists on the route to terminals, and the terminal receives the infrared carrier wave sent by the LED lamp through an infrared transmitter-receiver, and acquires GPS data codes from the infrared carrier wave, analyzes the GPS data codes, obtains GPS data, determines the current position according to the GPS data, and plans the navigation route between the current position and the target position according to the current position, realizing indoor positioning and indoor navigation.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for indoor navigation according to a first embodiment of the present disclosure.

FIG. 2 is a flowchart of a method for indoor navigation according to a second embodiment of the present disclosure.

FIG. 3 is a structural block diagram of a device for indoor navigation according to a third embodiment of the present disclosure.

FIG. 4 is a structural block diagram of a device for indoor navigation according to a fourth embodiment of the present disclosure.

FIG. 5 is a structural block diagram of an indoor navigation system according to an embodiment of the present disclosure.

FIG. 6 is an organization chart of receiving infrared carrier wave and realizing indoor navigation by a terminal according to an embodiment of the present disclosure.

FIG. 7 schematically illustrates a block diagram of an electronic device for executing the method according to the present disclosure.

FIG. 8 schematically illustrates a storage unit for holding or carrying program codes for realizing the method according to the present disclosure.

### DESCRIPTION OF THE EMBODIMENTS

To clarify the objectives, technical solutions and advantages of the embodiments of the present disclosure, the technical solutions in the embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, a person skilled in the art may obtain other embodiments without creative labor, which shall all fall within the protection scope of the present disclosure.

### Embodiment 1

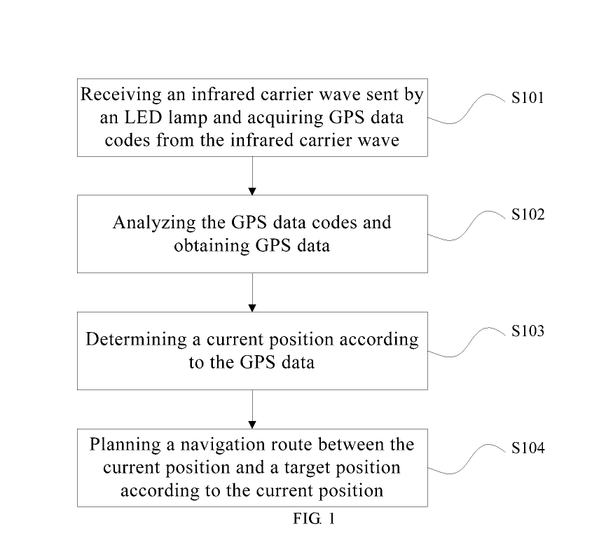

Refer to FIG. 1, which is a flowchart of a method for indoor navigation according to a first embodiment of the present disclosure.

In order to solve the problem of indoor navigation in large buildings, an embodiment of the present disclosure provides a method for indoor navigation, which may be executed by a terminal with an infrared transmitter-receiver. As shown in FIG. 1, the method may include the following steps.

Step S101: Receiving an infrared carrier wave sent by an LED (Light-Emitting Diode) lamp, and acquiring GPS (Global Positioning System) data codes from the infrared carrier wave.

In this step, the LED lamp is fixed on a ceiling, so there is no obstacle between the LED lamp and the terminal. At present, terminals such as mobile phones and tablet computers are generally integrated with a short-distance sensor, and the short-distance sensor has an infrared transmitter-receiver, so the short-distance sensor may measure distances through infrared rays. The infrared transmitter-receiver in the short-distance sensor receives infrared carrier waves, realizing receiving of the infrared carrier wave without adding an element in the terminals. It needs to be noted that, the infrared carrier wave sent by the LED map is modulated with the GPS data codes, so the GPS data codes may be acquired from the infrared carrier wave.

Step S102: Analyzing the GPS data codes and obtaining GPS data.

In this step, the GPS data codes may be NMEA (National Marine Electronics Association) codes. The NMEA codes are a set of standard information for defining output of the receiver, and the most frequently-used format is GGA (Global Positioning System Fix Data), including GPS data such as positioning time, latitude, longitude, height, speed and date.

Step S103: Determining a current position according to the GPS data.

At narrow positions such as corridors and elevator rooms, usually only one LED lamp is needed, so a terminal may receive the infrared carrier wave sent by only one LED lamp and obtain a set of GPS data. Indoor navigation software in the terminal uploads the set of GPS data onto a navigation map to represent the current position. The positioning accuracy is the lighting scope of the LED lamp.

To meet the demand on lighting brightness, a room with a large area inside is usually configured with more than one LED lamp, so the terminal may receive the infrared carrier waves sent by two or more LED lamps, thus obtaining two or more sets of GPS data.

When receiving two sets of GPS data, the indoor navigation software built in the terminal processes the two sets of GPS data by dichotomy, and uploads the processed GPS data onto the navigation map to represent the current position. The positioning accuracy is the maximum radius of a lighting overlapped area of two adjacent LED lamps.

When receiving three or more than three sets of GPS data sent by the LED lamps, the three or more than three sets of GPS data may be calculated by using a range-based algorithm and a range-free algorithm, and the calculated GPS data are uploaded into the navigation map to represent the current position. The positioning accuracy may reach a centimeter level.

The range-free algorithm does not need to determine distance and angle information, and just realizes according to network connectivity information, etc. Main algorithms include centroiding algorithm, APIT (approximate point-in-triangulation teat), and DV-Hop (distance vector-hop) positioning algorithm.

A range-based algorithm is used for measuring information about distance or angle between nodes, and node positions are calculated by using trilateration, triangulation or maximum likelihood estimate. Main algorithms include: TOA (time of arrival), TDOA (Time Difference of Arrival), AOA (Angle of Arrival) and RSSI (Received Signal Strength Indication).

Step S104: Planning a navigation route between the current position and a target position according to the current position.

In this step, the terminal may map the current position obtained by positioning and a target position input by a user to a navigation map, and plans the navigation route between the current position and the target position according to a navigation algorithm.

According to the method for indoor navigation provided by the first embodiment of the present disclosure, the infrared carrier wave sent by the LED lamp may be received; the terminal receives the infrared carrier wave sent by the LED lamp through the infrared transmitter-receiver therein, and acquires GPS data codes from the infrared carrier wave, analyzes the GPS data codes, obtains GPS data, determines the current position according to the GPS data, and plans the navigation route between the current position and the target position according to the current position, thus realizing indoor positioning and indoor navigation.

### Embodiment 2

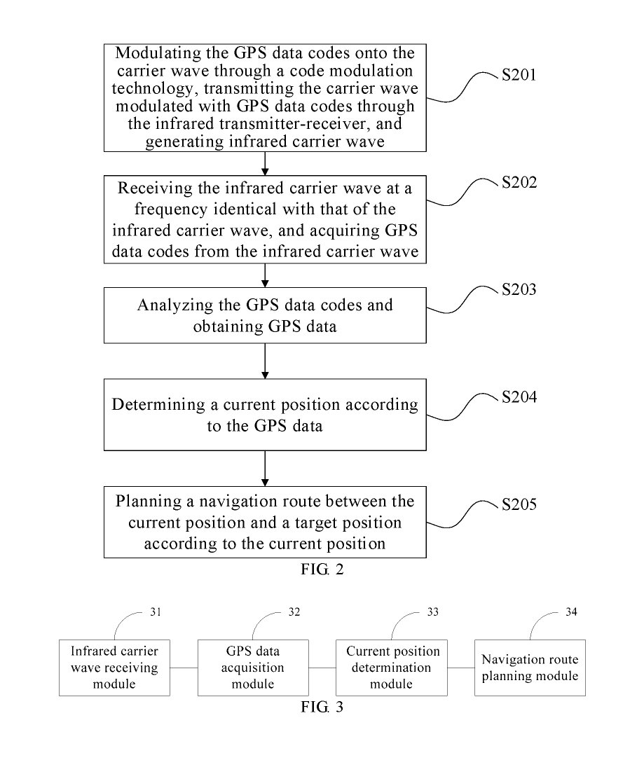

FIG. 2 is a flowchart of a method for indoor navigation according to a second embodiment of the present disclosure.

The second embodiment of the present disclosure provides a method for indoor navigation. As shown in FIG. 2, the method may include the steps as follows.

Step S201: Modulating the GPS data codes onto the carrier wave through a code modulation technology, transmitting the carrier wave modulated with the GPS data code with GPS data codes through the infrared transmitter-receiver of the LED lamp, and generating an infrared carrier wave.

In this step, the infrared carrier wave is a 38 KHz carrier wave.

Step S202: Receiving the infrared carrier wave at a frequency identical with that of the infrared carrier wave, and acquiring GPS data codes from the infrared carrier wave.

In this step, the terminal is internally provided with an infrared transmitter-receiver, and the infrared transmitter-receiver receives the infrared carrier wave at a frequency 38 KHz, and acquires GPS data codes from the infrared carrier wave. Wherein, the GPS data codes are 50 Hz data codes.

Step S203: Analyzing the GPS data codes and obtaining GPS data.

Step S204: Determining a current position according to the GPS data.

Step S205: Planning a navigation route between the current position and a target position according to the current position.

According to the method for indoor navigation provided by the second embodiment of the present disclosure, the infrared carrier wave sent by the LED lamp may be received; the terminal receives the infrared carrier wave sent by the LED lamp through the infrared transmitter-receiver therein, and acquires GPS data codes from the infrared carrier wave, analyzes the GPS data codes, obtains GPS data, determines the current position according to the GPS data, and plans the navigation route between the current position and the target position according to the current position, thus realizing indoor positioning and indoor navigation.

### Embodiment 3

FIG. 3 is a structural block diagram of a device for indoor navigation according to a third embodiment of the present disclosure.

The third embodiment of the present disclosure provides a device for indoor navigation. As shown in FIG. 3, the device capable of executing the method for indoor navigation provided by the first embodiment of the present disclosure may include: an infrared carrier wave receiving module 31, a GPS data acquisition module 32, a current position determination module 33 and a navigation route planning module 34.

In this embodiment of the present disclosure, the infrared carrier wave receiving module 31 is used for receiving an infrared carrier wave sent by an LED lamp and acquiring GPS data codes from the infrared carrier wave: the GPS data acquisition module 32 is used for analyzing the GPS data codes and obtaining GPS data; the current position determination module 33 is used determining a current position according to the GPS data; and the navigation route planning module 34 is used for planning a navigation route between the current position and a target position according to the current position.

In the infrared carrier wave receiving module 31, the LED lamp is fixed on a ceiling, and there is no obstacle between the LED lamp and the terminal. At present, terminals such as mobile phones and tablet computers are generally integrated with a short-distance sensor, and the short-distance sensor has an infrared transmitter-receiver, so the short-distance sensor may measure distances through infrared rays. The infrared transmitter-receiver in the short-distance sensor receives infrared carrier waves, realizing receiving of the infrared carrier wave without adding an element in the terminals. It needs to be noted that, the infrared carrier wave sent by the LED map is modulated with the GPS data codes, so the GPS data codes may be acquired from the infrared carrier wave.

In the GPS data acquisition module 32, the GPS data codes may be NMEA (National Marine Electronics Association) codes. The NMEA codes are a set of standard information for defining output of the receiver, and the most frequently-used format is GGA (Global Positioning System Fix Data), including GPS data such as positioning time, latitude, longitude, height, speed and date.

In the current position determination module 33, narrow positions such as corridors and elevator rooms, usually only one LED lamp is configured, so a terminal may receive the infrared carrier wave sent by only one LED lamp and obtain a group of GPS data. Indoor navigation software in the terminal uploads the set of GPS data onto a navigation map to represent the current position. The positioning accuracy is the lighting scope of the LED lamp.

To meet the demand on lighting brightness, a room is usually configured with more than one LED lamp, so the terminal may receive the infrared carrier waves sent by two or more LED lamps, thus obtaining two or more sets of GPS data.

When receiving two sets of GPS data, the indoor navigation software in the terminal processes the two sets of GPS data by dichotomy, and uploads the processed GPS data onto the navigation map to represent the current position. The positioning accuracy is the maximum radius of a lighting overlapped area of two adjacent LED lamps.

When receiving three or more than three sets of GPS data sent by the LED lamps, the three or more than three sets of GPS data may be calculated by using a range-based algorithm and a range-free algorithm, and the calculated GPS data are uploaded into the navigation map to represent the current position. The positioning accuracy may reach a centimeter level.

The range-free algorithm does not need to determine distance and angle information, and just realizes according to network connectivity information, etc. Main algorithms include centroiding algorithm, APIT (approximate point-in-triangulation teat), and DV-Hop (distance vector-hop) positioning algorithm.

A range-based algorithm is used for measuring information about distance or angle between nodes, and node positions are calculated by using trilateration, triangulation or maximum likelihood estimate. Main algorithms include: TOA (time of arrival), TDOA (Time Difference of Arrival). AOA (Angle of Arrival) and RSSI (Received Signal Strength Indication).

In the navigation route planning module 34, the terminal may map the current position obtained by positioning and a target position input by a user to a navigation map, and plans the navigation route between the current position and the target position according to a navigation algorithm.

According to the method for indoor navigation provided by the third embodiment of the present disclosure, the infrared carrier wave sent by the LED lamp may be received: the terminal receives the infrared carrier wave sent by the LED lamp through the infrared transmitter-receiver therein, and acquires GPS data codes from the infrared carrier wave, analyzes the GPS data codes, obtains GPS data, determines the current position according to the GPS data, and plans the navigation route between the current position and the target position according to the current position, thus realizing indoor positioning and indoor navigation.

### Embodiment 4

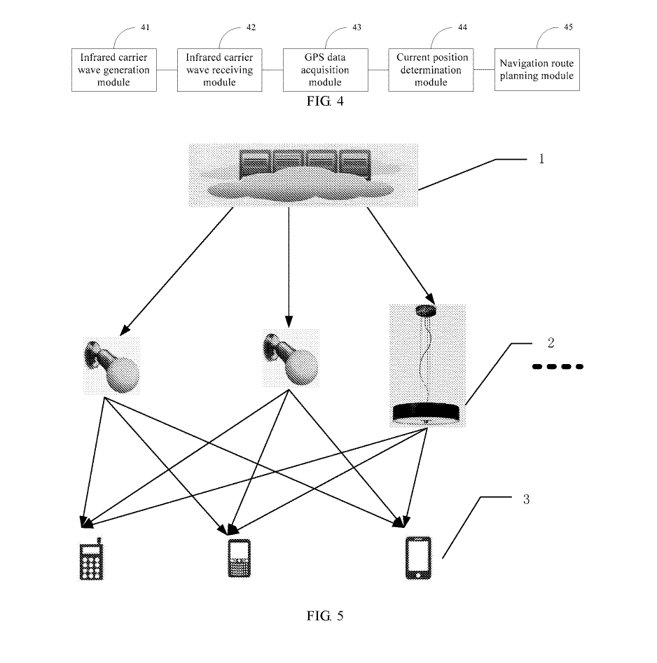

FIG. 4 is a structural block diagram of a device for indoor navigation according to a fourth embodiment of the present disclosure.

The fourth embodiment of the present disclosure provides a device for indoor navigation, capable of executing the method for indoor navigation provided by the second embodiment of the present disclosure. As shown in FIG. 4, the device may include: an infrared carrier wave generation module 41, an infrared carrier wave receiving module 42, a GPS data acquisition module 43, a current position determination module 44 and a navigation route planning module 45.

In this embodiment of the present disclosure, the infrared carrier wave generation module 41 is used for modulating the GPS data onto the carrier wave through a coding modulation technology, transmitting the carrier wave modulated with the GPS data through the infrared transmitter-receiver of the LED lamp, and generating the infrared carrier wave; the infrared carrier wave receiving module 42 is used for receiving an infrared carrier wave at a frequency identical with that of the infrared carrier wave and acquiring GPS data codes from the infrared carrier wave; the GPS data acquisition module 43 is used for analyzing the GPS data codes and obtaining GPS data; the current position determination module 44 is used determining a current position according to the GPS data; and the navigation route planning module 45 is used for planning a navigation route between the current position and a target position according to the current position.

In the infrared carrier wave generation module 41, the infrared carrier wave is a 38 KHz carrier wave, and the GPS data codes carried by the infrared carrier wave are 50 Hz data codes.

According to the method for indoor navigation provided by the fourth embodiment of the present disclosure, the infrared carrier wave sent by the LED lamp may be received; the terminal receives the infrared carrier wave sent by the LED lamp through the infrared transmitter-receiver therein, and acquires GPS data codes from the infrared carrier wave, analyzes the GPS data codes, obtains GPS data, determines the current position according to the GPS data, and plans the navigation route between the current position and the target position according to the current position, thus realizing indoor positioning and indoor navigation.

FIG. 5 is a structural block diagram of an indoor navigation system according to an embodiment of the present disclosure.

As shown in FIG. 5, an indoor positioning control center 1 modulates the GPS data onto the carrier wave through a coding modulation technology, transmits the carrier wave modulated with the GPS data through an infrared transmitter-receiver of an LED lamp 2, and generates the infrared carrier wave; a terminal 3 receives an infrared carrier wave sent by the LED lamp 2 and acquiring GPS data codes from the infrared carrier wave, analyzes the GPS data codes, obtains GPS data, determines a current position according to the GPS data; and plans a navigation route between the current position and a target position according to the current position, thus realizing indoor positioning and indoor navigation.

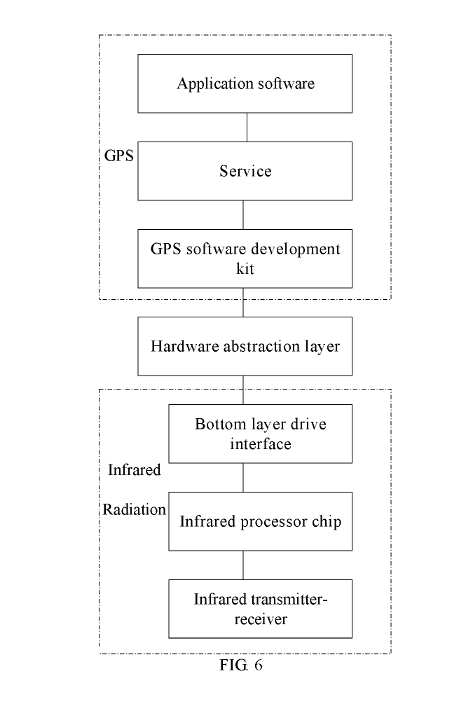

In this embodiment of the present disclosure, the organization of the terminal for receiving infrared carrier wave and realizing indoor navigation may be seen in FIG. 6.

GPS portions include GPS device application software (GPS APP), GPS service and GPS software development kit (GPS lib) in the indoor positioning control center. The GPS portions may be connected to lower layers through a HAL (Hardware Abstraction Layer). Infrared (IR, Infrared Radiation) portions include a bottom layer drive interface, an infrared processor chip and an infrared transmitter-receiver LED. Wherein, the infrared transmitter-receiver LED may be integrated with functions of an infrared transmitter unit and an infrared receiver unit, meaning that the infrared transmitter-receiver LED may transmit infrared light and may also sense infrared light.

Based on FIG. 6, first, the infrared transmitter-receiver LED of the terminal receives the infrared carrier wave sent by the LED lamp; then, the infrared processor chip acquires GPS data codes from the infrared carrier wave, analyzes the GPS data codes, and obtains GPS data; next, the HAL layer uploads the GPS data obtained by the infrared processor chip to the GPS software development kit (GPS lib), the GPS service and the GPS device application software (GPS APP); and the application software of a GPS device maps the GPS data into an indoor navigation map, determines the current position, and plans a navigation route between the current position and a target position according to the current position.

The embodiment of the present disclosure further provides a non-transitory computer readable medium storing executable instructions that, when executed by an electronic device, cause the electronic device to execute the method for indoor navigation above.

The embodiment of the present disclosure further provides a computer program, comprising executable instructions, wherein the executable instructions operate on an electronic device such that the electronic device executes the method for indoor navigation above.

The device embodiments described above are schematic only, wherein units described as separate components may be or cannot be separated physically; components which are adopted as display units display may be or cannot be physical units, namely located on a place or distributed to a plurality of network units. The purpose of the schemes in the embodiment may be achieved via partial or all modules according to actual requirements. A person skilled in the art may understand and implement without creative labor.

Each of devices according to the embodiments of the disclosure may be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

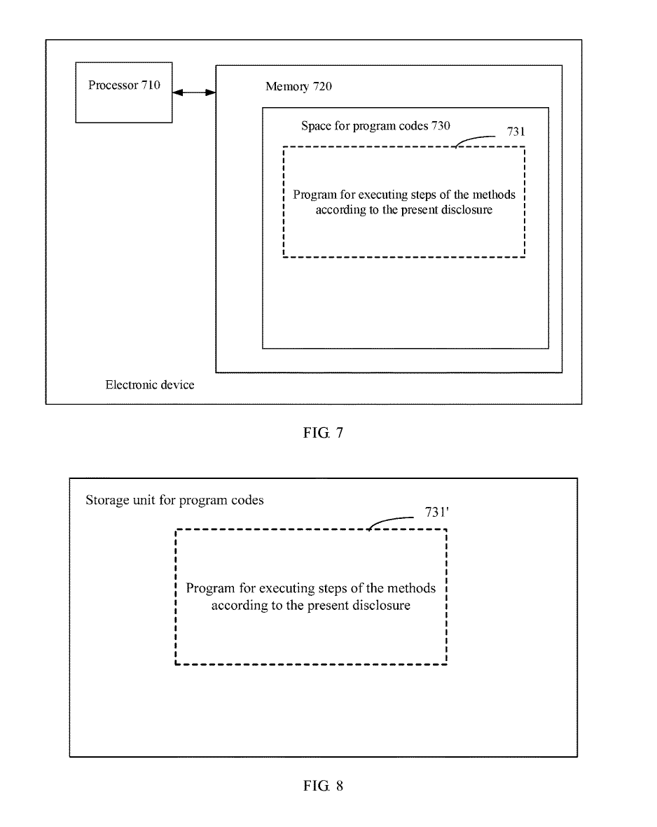

For example, FIG. 7 illustrates a block diagram of an electronic device for executing the method according to the disclosure. Traditionally, the electronic device includes a processor 710 and a computer program product or a computer readable medium in form of a memory 720. The memory 720 could be electronic memories such as flash memory, EEPROM (Electrically Erasable Programmable Read-Only Memory), EPROM, hard disk or ROM. The memory 720 has a memory space 730 for executing program codes 731 of any steps in the above methods. For example, the memory space 730 for program codes may include respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 8. The memory cells may be provided with memory sections, memory spaces, etc., similar to the memory 720 of the server as shown in FIG. 7. The program codes may be compressed for example in an appropriate form. Usually, the memory cell includes computer readable codes 731′ which may be read for example by processors 710. When these codes are operated on the server, the server may execute respective steps in the method as described above.

Through the description of the above embodiments, a person skilled in the art may clearly know that the embodiments may be implemented by software and necessary universal hardware platforms, or by hardware. Based on this understanding, the above solutions or contributions thereof to the prior art may be reflected in form of software products, and the computer software products may be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they may modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A method for indoor navigation, comprising:
receiving an infrared carrier wave sent by an LED lamp and acquiring GPS data codes from the infrared carrier wave;
analyzing the GPS data codes and obtaining GPS data;
determining a current position according to the GPS data;
planning a navigation route between the current position and a target position according to the current position.

2. The method according to claim 1, wherein, before receiving an infrared carrier wave sent by an LED lamp and acquiring GPS data codes from the infrared carrier wave, the method further comprises:
modulating the GPS data codes onto the carrier wave through a code modulation technology, transmitting the carrier wave modulated with GPS data codes through the infrared transmitter-receiver of the LED lamp, and generating the infrared carrier wave.

3. The method according to claim 1, wherein receiving the infrared carrier wave sent by the LED lamp comprises:
receiving the infrared carrier wave at a frequency identical with the infrared carrier wave.

4. The method according to claim 3, wherein, the infrared carrier wave is a 38 KHz carrier wave.

5. The method according to claim 1, wherein, the GPS data codes are 50 Hz data codes.

6. An electronic device, comprising:
at least one processor; and
a memory communicably connected with the at least one processor for storing instructions executable by the at least one processor, wherein execution of the instructions by the at least one processor causes the at least one processor to:
receive an infrared carrier wave sent by an LED lamp and acquire GPS data codes from the infrared carrier wave:
analyze the GPS data codes and obtain GPS data;
determine a current position according to the GPS data;
plan a navigation route between the current position and a target position according to the current position.

7. The electronic device according to claim 6, wherein execution of the instructions by the at least one processor causes the at least one processor to further:
modulate the GPS data codes onto the carrier wave through a code modulation technology, transmit the carrier wave modulated with GPS data codes through the infrared transmitter-receiver of the LED lamp, and generate infrared carrier wave.

8. The electronic device according to claim 6, wherein, receive an infrared carrier wave sent by an LED lamp and acquiring GPS data codes from the infrared carrier wave comprises:
receiving the infrared carrier wave at a frequency identical with the infrared carrier wave.

9. The electronic device according to claim 8, wherein, the infrared carrier wave is 38 KHz carrier wave.

10. The electronic device according to claim 6, wherein, the GPS data codes are 50 Hz data codes.

11. A non-transitory computer readable medium storing executable instructions that, when executed by an electronic device, cause the electronic device to:
receive an infrared carrier wave sent by an LED lamp and acquire GPS data codes from the infrared carrier wave;
analyze the GPS data codes and obtain GPS data;
determine a current position according to the GPS data; and
plan a navigation route between the current position and a target position according to the current position.

12. The non-transitory computer readable medium according to claim 11, wherein, before receive an infrared carrier wave sent by an LED lamp and acquiring GPS data codes from the infrared carrier wave, the electronic device is further caused to:
modulate the GPS data codes onto the carrier wave through a code modulation technology, transmit the carrier wave modulated with GPS data codes through the infrared transmitter-receiver of the LED lamp, and generate the infrared carrier wave.

13. The non-transitory computer readable medium according to claim 11, wherein receive the infrared carrier wave sent by the LED lamp comprises:
receiving the infrared carrier wave at a frequency identical with the infrared carrier wave.

14. The non-transitory computer readable medium according to claim 13, wherein, the infrared carrier wave is a 38 KHz carrier wave.

15. The non-transitory computer readable medium according to claim 11, wherein, the GPS data codes are 50 Hz data codes.
